(19) United States
(12) Patent Application Publication
(10) Pub. No.: US 2008/0003013 A1
(43) Pub. Date: Jan. 3, 2008

(54) Cartridge split rail clip

(75) Inventors: Thomas J. Martin, Sanford, NC (US); James H. Jones, Fayetteville, NC (US); Donald R. Huck, Raleigh, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/478,862

(22) Filed: Jun. 30, 2006

(51) Int. Cl. G03G 15/00

(52) U.S. Cl. 399/109

(57) ABSTRACT

A reinforcing clip for use in the toner cartridge remanufacturing industry is disclosed. The reinforcing clip secures a magnetic roller section as it is positioned on a toner hoper reservoir of a toner cartridge. The toner hopper reservoir has a limited amount of space available to mount such a clip. The present invention provides a securing force which is about perpendicular to the fastening force of the reinforcing clip's two securing legs.

### FIELD OF INVENTION

The present invention relates to remanufacturing of imaging process cartridges, such as printer toner cartridges, and more particularly to reinforcing rail clip for use in adding rigidity and stability to a seam in a remanufactured image process cartridge.

### BACKGROUND

Printer cartridges are typically designed to provide the consumer a certain number of print copies before the toner or ink is exhausted. The total number of prints varies depending on the type, quality and density of the print provided by the printer. After all of the toner or ink is spent, the cartridges are either thrown away or recycled.

An emerging industry has developed that deals with the recycling of printer cartridges. Typically, the OEM (Original Equipment Manufactured) cartridge is recycled by a cartridge remanufacturer, who receives spent printer cartridges and refurbishes them. The toner cartridge remanufacturing process typically entails disassembling, cleaning, refurbishing and reassembling the cartridge. The last step of the refurbishment process typically includes refilling the cartridge with toner and repackaging the cartridge.

A typical OEM toner cartridge comprises an assembled plastic housing. The material of the housing may be molded plastic or other plastic composite. Where the various parts of the cartridge join together, a seam may exist. In some laser toner cartridges, the seam may be held together by ultrasonic welding. On other types of toner cartridges glue or other adhesive may be used to hold the seam in place.

Once the seam or seams have been broken and the various parts of the toner cartridge separated, the worn or broken parts may be replaced. As the cartridge is reassembled, a clip may be used to hold the pieces in place instead of ultrasonically welding the seam of gluing. The use of a clip, such as those described in U.S. Pat. No 6,240,605, issued to Stevens et al., assigned to the present assignee, and its contents are incorporated herein, may be used in order to facilitate the remanufacturing of a remanufactured cartridge. However, those clips as described in Stevens et al. require two opposing surfaces to create a seam. The two ends of the clip provide a securing and stabilizing force against the seam by providing pulling the two sections towards each other.

However, in some newer toner cartridges, the seam may be formed by two orthogonally joining surfaces. In this case, the prior art clips do not have enough surface for its legs to attach to and still provide enough securing and stabilizing force to hold the reassembled cartridge together. The present invention may be used to secure a seam in a toner cartridge where the securing and stabilizing force is applied by an elongated arm that extends away from the one of the legs of a reinforcing clip.

### SUMMARY

A reinforcing clip for use in securing a seam in a remanufactured image process cartridge having a toner hopper reservoir section and a magnetic roller section, said seam formed from the joining of said toner hopper reservoir section and said magnetic roller section, the clip comprising a first securing edge connected to a second securing edge by a connecting member, said clip attaching to a projection along said seam, said reinforcing clip further comprising an elongated arm attached to said second end, said elongated arm securing said magnetic roller section against said toner hopper reservoir.

A remanufactured image process cartridge comprising a toner hopper reservoir attached to a magnetic roller section, wherein an orthogonal seam is formed from the joining of said toner hopper reservoir with said magnetic roller section, said magnetic roller section secured to said toner hopper reservoir by a reinforcing clip, said clip having a first end connected by a connecting member to a second end and an elongated arm protruding from said second end, said protruding arm exerting a force on said magnetic roller section against said toner hopper reservoir.

A more complete understanding of the present invention, as well as further features and advantages of the invention, will be apparent from the following detailed description and the accompanying drawings.

### BRIEF DESCRIPTION OF THE DRAWINGS

FIG. 1 shows a view of a fully assembled HP11A toner cartridge for use in an HP2410/2420/2430 family of printers.

FIG. 2 shows an exploded view of a toner hopper assembly of the HP11A laser toner cartridge with the waste bin assembly removed.

FIG. 3A shows an end view of a split rail clip in accordance with one aspect of the present invention.

FIG. 3B shows a side view of the split rail clip of FIG. 3A.

FIG. 3C shows a side perspective view of the split rail clip of FIG. 3A.

FIG. 4 shows an end view of another split rail clip according to another embodiment of the present invention.

FIG. 5 displays an end view of yet another split rail clip according to another embodiment of the present invention.

FIG. 6 shows an end view of yet another split rail clip according to another embodiment of the present invention.

FIG. 7 displays an end view of yet another split rail clip according to another embodiment of the present invention.

FIG. 8 shows a cutaway view of a seam created by the joining of a toner hopper reservoir and a magnetic roller section of the cartridge of FIG. 1.

FIG. 9 shows the rail clip of FIGS. 3A-C installed on the seam of FIG. 8.

### DETAILED DESCRIPTION

The following detailed description of preferred embodiments refers to the accompanying drawings, which illustrate specific embodiments of the invention. In the discussion that follows, specific systems and techniques for repairing, manufacturing or remanufacturing an imaging cartridge, such as a toner cartridge are used as examples. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

In the toner cartridge refurbishment industry, the used toner cartridges are collected and serviced by toner cartridge remanufacturers. The first step in the refurbishment process is the disassembling of the spent cartridges. Next, the internal components are separated. Non-functioning components are replaced, and the remaining components, as well as the body of the device undergo a cleaning process. In the final step the device is reassembled and new toner is added to the toner cartridge. The refurbished device is then packaged and distributed to the consumer.

Typically the OEM uses ultrasonic welding to hold sections of the cartridge together. These welds are broken when the cartridge is disassembled by the remanufacturer. Those skilled in the art appreciate that ultrasonic welding may be utilized on plastic or plastic composite materials. No other hardware is required to hold the sections of the cartridge in place after the ultrasonic welds are done.

During the disassembly of a toner cartridge, the ultrasonic welds are broken in order to separate the sections of the toner cartridge. The remanufacturer may use some type of sharp instrument such as a sharp blade or box cutter to sever the weld. Cutting the weld may be more time consuming than prying the sections apart with brute force. Some remanufacturers may decide that it is easier to use a screw driver, chisel or other type of instrument to pry the sections apart.

After the cartridge has been completely disassembled, and the worn or used components identified and replaced, the toner cartridge is reassembled. During the reassembly of the cartridge, the remanufacturer may choose not to re-weld the sections together. In order to ultrasonically weld the sections, the remanufacturer may have to invest in expensive welding equipment that maybe too cost prohibitive. Additionally, after the ultrasonic weld is broken, material at the seam may be compromised enough that there is not be enough material remaining to re-weld.

One alternative that has been developed for securing the sections of a toner cartridge are clips. Clips are an excellent alternative to ultrasonic welding. Using a clip to hold the various sections together allows the remanufacturer to easily disassemble the cartridge during a later refurbishment. No welding equipment is necessary when utilizing a clip. However, previous clips used in the toner remanufacturing industry are designed to provide a securing and stabilizing force in diametrically opposed directions. The seams on these types of cartridges are formed from the mating of two parallel surfaces. The legs of the prior art clip fasten to these parallel surfaces and push them together. However in some newer cartridges, the two parallel surfaces that form the seam may not have enough area to attach these prior art clips. The present invention is designed to provide a securing and stabilizing force necessary to keep this type of seam sealed after the remanufacturing process.

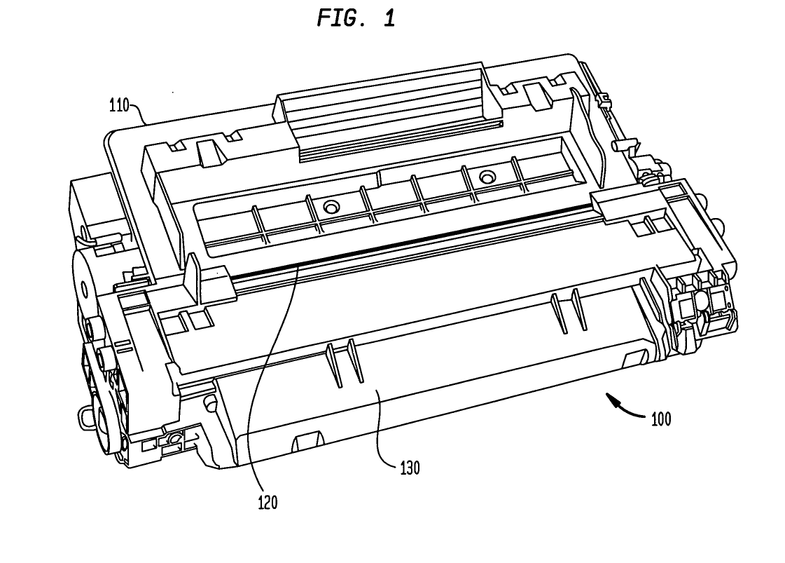

The present invention is more clearly understood in reference to the cartridge 100 displayed in FIG. 1. The cartridge 100 may be used in an HP2410/2420/2430 family of printers. Cartridge 100 has three main sections, the toner hopper reservoir 110, the magnetic roller section 120 and the waste bin 130. In the OEM cartridge, the toner hopper reservoir 110 and the magnetic roller section 120 may be held together by ultrasonic welds. When the cartridge 100 is disassembled, the ultrasonic weld is broken and the parts are separated.

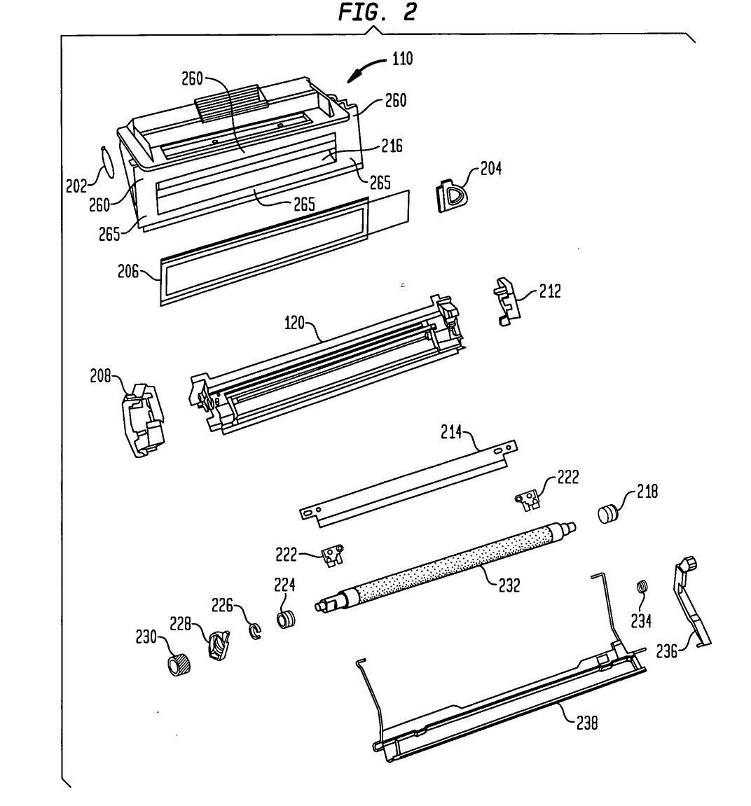

FIG. 2 displays an exploded view of cartridge 100 with the waste bin assembly 130 already removed. Toner cartridge 100 does not have any opening in the toner hopper reservoir 110 to refill toner, so the remanufacturer must create such an opening in order to install new toner. The opening is sealed by placing a toner hopper cap 202 over the opening.

When cartridge 100 is reassembled, a seal 206 is first placed over the toner hopper opening 216. The seal 206 has a removable plastic portion attached to a pull tab 204 that covers the toner hopper opening 216. The seal keeps toner confined in the toner hopper reservoir 110 during shipment of the cartridge 100. Prior to installing the cartridge 100 in a printer, the removable plastic portion is removed by pulling the pull tab 204. Removing the removable portion allows toner to flow from the toner hopper reservoir 110 into the magnetic roller section 120.

Once the seal 206 is place on the toner hopper reservoir 110, the magnetic roller section 120 is then placed on top of the toner hopper reservoir 110. The present invention is used to secure the magnetic roller section 120 against the seal 206 and the toner hopper reservoir 110. Next, a doctor blade 214 and magnetic roller wiper tabs 222 are secured on top of the magnetic roller section 120 with two securing screws (not shown). The magnetic roller assembly consisting of the long magnetic roller bushing 218, magnetic roller 232, short magnetic roller bushing 224, stabilizer bearing 226, stabilizer 228 and magnetic roller drive gear 230 are assembled and placed in the magnetic roller section 120.

Next, a drive side end plate 208 and a contact side end plate 212 are placed on the sides of the magnetic roller section 120 and are secured into place with end plate screws (not shown). Once the end plates 208, 212 are secured into place, a drum shutter 238 is then attached. Connected to the drum shutter is a drum shutter tension spring 234 and a drum shutter actuator arm 236. The movement of the drum shutter actuator arm 236 causes the drum shutter to open and expose the OPC (Organic Photo Conductor) drum (not shown).

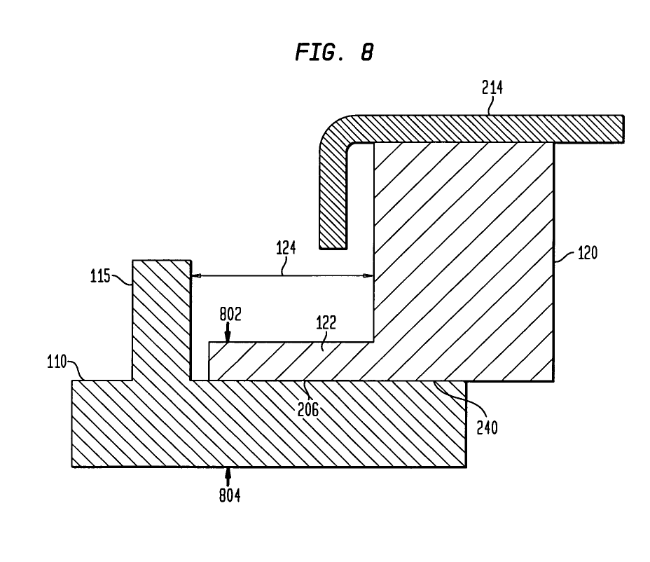

FIG. 8 displays a cutaway view of toner cartridge 100 at the juncture of the toner hopper reservoir 110 and magnetic roller section 120 at the top section of the toner hopper opening 216. Mounted on top of magnetic roller section 120 is the doctor blade 214. As shown in FIG. 8, a seam 240 is formed at the location where the top of the toner hopper reservoir 110 is joined with the top of the magnetic roller section 120. A flange 122 extends away from the magnetic roller section 120 towards a ledge 115 of toner hoper reservoir 110. In between the ledge 115 and the main body of the magnetic roller section 120 is a gap 124. The gap 124 of cartridge 100 is about 0.4″ (10.2 mm). As shown in FIG. 8, the seal 206 is compressed in the seam 240. The seam 240 extends around the perimeter of the toner hopper opening 216.

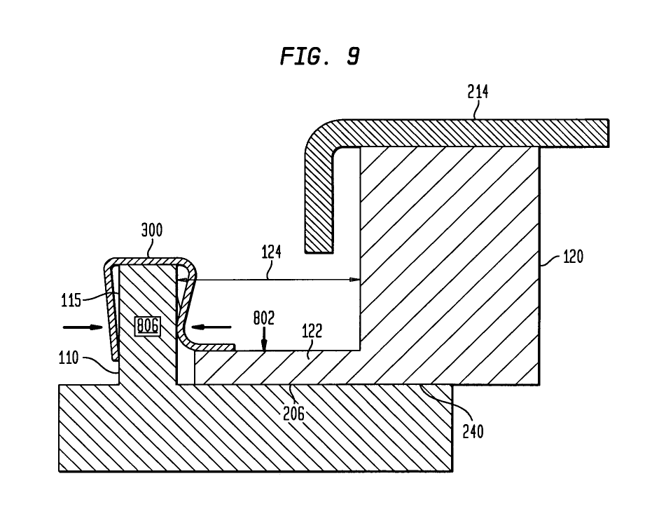

The prior art clips are not usable to stabilize and secure this type of seam due to the lack of a sufficient securing surface. Prior art clips apply a securing force in opposing directions, typically a downward direction 802, and an upward direction 804. As illustrated in FIGS. 8 and 9, all forces exerted by the prior art clips as well as the present invention are represented with dashed lines. In order to use a prior art clip, one leg of the clip would need to be small enough to fit into the gap 124 and be placed against the flange 122. The other leg of such clip would have to be placed at a location on the toner hopper reservoir 110 to provide an upward force 804 necessary to secure the seam 240. This type of clip would have to be molded around the ledge 115 as well as the rest of the contours of the toner hopper reservoir 110. The present invention provides a securing force for a cartridge 100 of this type.

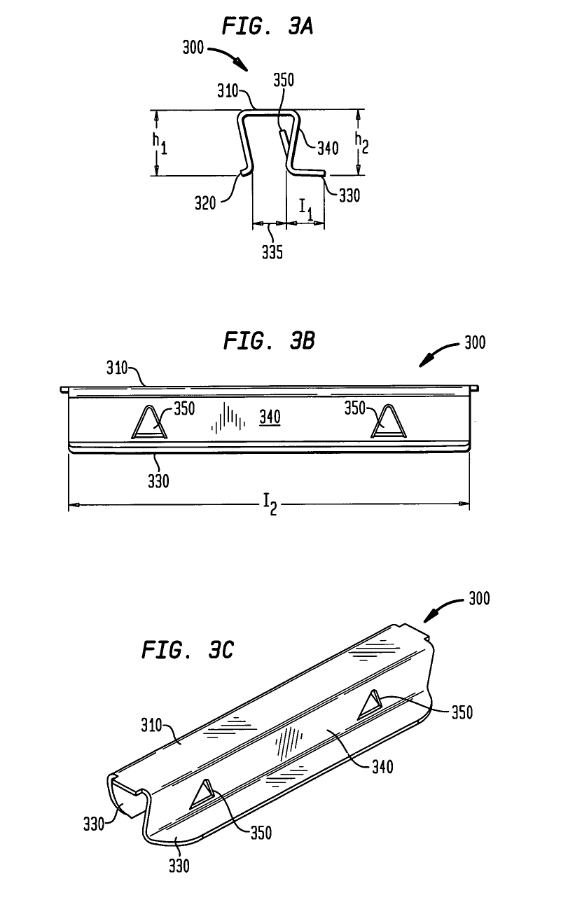

A reinforcing clip 300 in accordance with one aspect of the present invention is displayed in FIGS. 3A-C. The reinforcing clip 300 has a first securing leg 320 connected to a second securing leg 340 by a connecting member 310. Opposite the connecting member 310 is an opening 335 which is in between the first securing leg 320 and the second securing leg 340. Typically the opening 335 is slightly smaller than the thickness of ledge 115 of the toner hopper reservoir 110. Attached to second securing leg 340 is an elongated arm 330 having a length of l₁ which extends away from the second securing leg 340 and is roughly parallel with connecting member 310. The length l₁ of the elongated arm 330 may vary with the dimension of gap 124. In the embodiment of FIGS. 3A-C, the length l₁ is about 0.12″ (3.0 mm).

Located on the second securing leg is a securing protrusion 350. In the preferred embodiment, the securing protrusion 350 is a barb that is triangularly shaped. As shown in FIG. 3B, the securing protrusion 350 is formed from a cut made in the wall of the second securing leg 340 and is bent inwards toward the first securing leg 320. Instead of a pointed barb, the securing protrusion 350 may have a smooth surface. Alternatively, the securing protrusion 350 may have multiple points.

The first securing leg extends away from the connecting member 310 by a height l₁ of about 0.222″ (5.64 mm). The end of the elongated arm protrudes a height l₂ from the connecting member 310 which is slightly longer than l₁. In the embodiment of FIGS. 3A-C, height l₂ is about 0.225″ (5.72 mm). As shown in FIG. 3B, reinforcing clip 300 has a length l₂. In a preferred embodiment, the length l₂ is about 1.25″ (31.75 mm). The number of reinforcing protrusions may depend on the length l₂ of the reinforcing clip 300. In the preferred embodiment, two securing protrusions 350 are created. The greater the length l₂ the more securing protrusions 350 may be required.

The reinforcing clip 300 is substantially rigid, thus ensuring that the reinforcing clip 300 is securely attached while providing enough clamping force to securely fasten the magnetic roller section 120 to the toner hopper reservoir 110. The reinforcing clip may be formed of any type of material that provides such rigidity such as steel, aluminum, plastic or plastic composite. The rigidity of the reinforcing clip 300 causes the elongated arm 330 to act like a spring when attached.

FIG. 9 displays the cutaway view of FIG. 8 with a reinforcing clip 300 attached to ledge 115 of toner hopper reservoir 110. When attached, the securing protrusion 350 of the reinforcing clip 300 extends into the ledge 115. Additionally, the first securing leg 320 and the second securing leg 340 exert a securing force 806 against the ledge 115. The combination of the securing force 806 in conjunction with the force exerted by the securing protrusion 350 provides additional stability for the reinforcing clip 300 as well as additional rigidity to the elongated arm 330. Unlike previous clips, reinforcing clip 300 provides only a downward force 802 against the seam 240. The downward force exerted by the elongated arm 330 is perpendicular to the securing force used to hold the reinforcing clip 300 in place on the ledge 115 of the toner hopper reservoir 110.

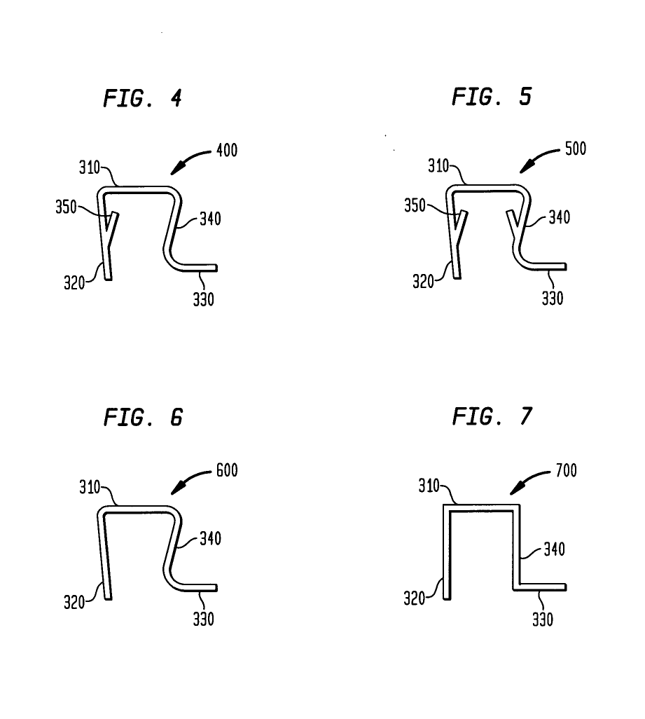

FIG. 4 displays an alternative embodiment of a reinforcing clip 400 in accordance with another aspect of the present invention. The reinforcing clip 400 has a securing protrusion 350 located on the first securing leg 320. The reinforcing clip 500 of FIG. 5 has securing protrusions 350 located on both the first securing leg 320 and the second securing leg 340. A reinforcing clip 600 with no securing protrusions 350 is displayed in FIG. 6. A rectangular shaped reinforcing clip 700 is shown in FIG. 7. All of the aforementioned reinforcing clips may be made out of the same materials and have roughly the same dimensions as previously described.

When reassembling the toner hopper reservoir 110 with the magnetic roller section 120, several clips may be used. With the preferred embodiment as described herein, three reinforcing clips 300 are recommended to be installed on the ledge 115 of the toner hopper reservoir 110. The preferred locations 260 as shown in FIG. 2 are in the top corners as well as in the center of the top of the toner hopper reservoir 110. In addition to the three reinforcing clips 300 installed at locations 260, three prior art clips may be used at locations 265. The prior art clips may be used at these locations 265 since there is enough securing surface. These locations 260 and 265 ensure that the seam 240 has sufficient securing force to prevent any toner from leaking out of the toner hopper reservoir 110 either during shipment or during normal operation.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A reinforcing clip used to secure a seam created from the joining of a toner hopper reservoir with a magnetic roller section of a toner cartridge, the clip comprising:
a first securing leg connected to a second securing leg by a connecting member,
said second securing leg further comprising an elongated arm
wherein said elongated arm provides a downward force about perpendicular to a securing force applied by said first securing leg towards said second securing leg when said clip is installed on said toner hopper reservoir.

2. The clip of claim 1 wherein said second securing leg further comprises a securing protrusion.

3. The clip of claim 2 wherein said securing protrusion is a barb.

4. The clip of claim 3 wherein said barb is triangular shaped.

5. The clip of claim 1 wherein said first securing leg further comprises a securing protrusion.

6. The clip of claim 5 wherein said securing protrusion is a barb.

7. The clip of claim 6 wherein said barb is triangular shaped.

8. The clip of claim 1 wherein said clip is metal.

9. The clip of claim 8 wherein said clip is aluminum.

10. The clip of claim 8 wherein said clip is steel.

11. The clip of claim 1 wherein said clip is plastic.

12. A remanufactured toner cartridge comprising:
a magnetic roller section and a toner hopper reservoir, said magnetic roller section secured against said toner hopper reservoir by a reinforcing clip said clip further comprising a first securing leg connected to a second securing leg by a connecting member, said second securing leg further comprising an elongated arm wherein said elongated arm provides a downward force about perpendicular to a securing force applied by said first securing leg towards said second securing leg when said clip is installed on said toner hopper reservoir.

13. The cartridge of claim 12 wherein said second securing leg of said reinforcing clip further comprises a securing protrusion

14. The cartridge of claim 13 wherein said securing protrusion is a barb.

15. The cartridge of claim 14 wherein said barb is triangular shaped.

16. The cartridge of claim 12 wherein said first securing leg of said reinforcing clip further comprises a securing protrusion

17. The cartridge of claim 16 wherein said securing protrusion is a barb.

18. The cartridge of claim 17 wherein said barb is triangular shaped.
